(19) United States
(12) Patent Application Publication
(10) Pub. No.: US 2008/0171247 A1
(43) Pub. Date: Jul. 17, 2008

(54) Reformer of fuel cell system

(76) Inventors: Chan-ho Lee, Suwon-si (KR); Ju-yong Kim, Suwon-si (KR); Sung-chul Lee, Suwon-si (KR); Yong-kul Lee, Suwon-si (KR); Jin-goo Ahn, Suwon-si (KR); Man-seok Han, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/893,739

(22) Filed: Aug. 17, 2007

(30) Foreign Application Priority Data
Nov. 2, 2006 (KR) 10-2006-0107864

(51) Int. Cl. H01M 8/18

(52) U.S. Cl. 429/20

(57) ABSTRACT

A reformer of a fuel cell system is disclosed. One embodiment of the reformer includes a reforming reactor generating reformed gas containing hydrogen by reforming hydrogen-containing fuel; and a CO remover removing carbon monoxide contained in the reformed gas generated from the reforming reactor, wherein the CO remover is disposed to be inclined in a predetermined angle to a moving path of the reformed gas exhausted from the reforming reactor and connected to the reforming reactor so as to communicate fluid therebetween, whereby the CO remover is not subject to the heat energy effect by a heat transfer effect due to air convection from the reforming reactor, making it possible to keep the CO remover an optimal state to improve reforming efficiency.

### CROSS-REFERENCE TO RELATED APPLICATIONS

This application claims the benefit of Korean Patent Application No. 10-2006-0107864, filed on Nov. 2, 2006, in the Korean Intellectual Property Office, the disclosure of which is incorporated herein by reference.

### BACKGROUND

1. Field

The present disclosure relates to a fuel cell system, and more particularly to a reformer of a fuel cell system having a reforming reactor and a shift reacting unit.

2. Description of the Related Technology

In general, a fuel cell system is a power generation system that generates electricity by an electro-chemical reaction between hydrogen and oxygen. Fuel cell systems have been researched and developed as an alternative which can solve energy and environmental issues. Hydrogen gas used for a fuel cell system may be obtained by reforming a hydrogen-containing fuel in a reformer. The fuel may be an alcoholic fuel, such as methanol, ethanol, etc.; and a hydrocarbon fuel, such as methane, propane, butane, etc.; or a natural gas fuel such as liquefied natural gas, etc.

### SUMMARY

One embodiment provides a reformer for use in a fuel cell, comprising: a reforming reactor comprising a first inlet and a first outlet, the first outlet being configured to exhaust a fluid generally in a first direction; a carbon monoxide remover comprising a second inlet and a second outlet, the carbon monoxide remover being configured to flow at least part of the fluid therethrough at least partially in a second direction different from the first direction; and a conduit configured to guide the at least part of the fluid from the first outlet to the second inlet.

The reforming reactor may be configured to flow the fluid therethrough generally in the first direction. The second inlet of the carbon monoxide remover may be configured to flow the at least part of the fluid therethrough generally in the second direction. The conduit may comprise a curved tube permitting fluid communication between the first outlet and the second inlet. The reforming reactor may be configured to operate at a first temperature, and the carbon monoxide remover may be configured to operate at a second temperature lower than the first temperature. The first temperature may be equal to or greater than about 700° C., and the second temperature may be from about 200° C. to about 400° C.

The carbon monoxide remover may comprise a water gas shifter and a preferential oxidation unit in fluid communication with each other, at least one of the water gas shifter and the preferential oxidation unit being configured to flow the fluid generally in the second direction. The water gas shifter may include the second inlet, and the preferential oxidation unit may include the second outlet.

The water gas shifter may comprise a first shifter and a second shifter in fluid communication with each other, the first shifter being configured to operate at a third temperature, the second shifter being configured to operate at a fourth temperature lower than the third temperature, wherein at least one of the first and second shifter is configured to flow the fluid generally in the second direction. The second shifter may comprise an inlet and an outlet aligned along an axis extending in the second direction. The reformer may further comprise another conduit permitting fluid communication between the first outlet of the reforming reactor and the inlet of the second shifter.

The reforming reactor may further comprise a heat source configured to supply heat to the reforming reactor, and the heat source may be configured to exhaust at least part of the heat in a third direction different from the second direction. The third direction may form an angle with the second direction, wherein the angle is between about 0° and about 180°. The third direction may be substantially the same as the first direction.

The first direction may form an angle with the second direction, wherein the angle is between about 0° and about 180°. The first inlet and first outlet of the reforming reactor may be positioned generally along a first axis extending in the first direction. The second inlet and second outlet of the carbon monoxide remover may be positioned generally along a second axis extending in the second direction.

Another embodiment provides a method of operating the reformer. The method comprises: flowing a fuel through the reforming reactor via the first inlet, thereby producing a reformed gas containing carbon monoxide; exhausting the reformed gas through the first outlet; flowing at least part of the gas through the conduit; and flowing the at least part of the gas through the carbon monoxide remover, thereby removing at least part of the carbon monoxide.

Another embodiment provides a reformer of a fuel cell system with a shift reacting unit installed to be inclined in a predetermined angle to a straight moving direction of reformed gas from the reforming reactor so as not to be affected by heat energy by the effects of heat transfer due to the air circulation from the reforming reactor so that the shift reacting unit is connected to the reforming reactor so as to communicate fluid therebetween.

Another embodiment provides a reformer of a fuel cell system with a shift reacting unit installed to be inclined in a predetermined angle to an exhaust direction that exhaust gas in a combustion chamber for supplying heat energy to a reforming reactor is exhausted.

A reformer of a fuel cell system according to another embodiment includes a reforming reactor generating reformed gas containing hydrogen by reforming hydrogen-containing fuel; and a CO remover removing carbon monoxide contained in the reformed gas generated from the reforming reactor, wherein the CO remover is disposed to be inclined in a predetermined angle to a moving path of the reformed gas exhausted from the reforming reactor and is connected to the reforming reactor so as to communicate fluid therebetween.

The moving path of the reformed gas is parallel to a first straight extension line connecting an inlet and an outlet of the reforming reactor. The moving direction of fluid flowing the CO remover is parallel to a second straight extension line connecting an inlet and an outlet of the CO remover, and the second extension line is maintained to be inclined in a predetermined angle to the first extension line.

When the CO remover comprises a water gas shifter and a preferential oxidation unit, the second extension line is a straight extension line connecting an inlet and an outlet of the water gas shifter. When the water gas shifter comprises a shifter for high temperature and a shifter for low temperature, the second extension line is a straight extension line connecting an inlet and an outlet of the shifter for low temperature. It further includes a curved tube for connecting the outlet of the reforming reactor and the inlet of the shifter for low temperature so as to communicate fluid therebetween.

A combustion unit for supplying heat energy to the reforming reactor is further included, and the moving path of the exhaust gas exhausted from the combustion unit and the moving path of the reformed gas are substantially parallel to each other. The tilt angle Θ satisfies a relation equation of 0° C.<Θ<180° C.

### BRIEF DESCRIPTION OF THE DRAWINGS

FIG. 1 is a schematic diagram of a fuel cell system with a reformer according to one embodiment.

FIG. 2 is a schematic view of a reformer having a carbon monoxide (CO) remover according to one embodiment.

FIG. 3 is a cross-sectional view of a reformer according to another embodiment.

FIG. 4 is a cross-sectional view of a transforming apparatus.

FIG. 5 is a schematic diagram of a fuel cell system with a CO transforming apparatus.

FIG. 6 is a perspective view of a reforming apparatus.

### DETAILED DESCRIPTION

Hereinafter, certain embodiments will be described in a more detailed manner with reference to the accompanying drawings.

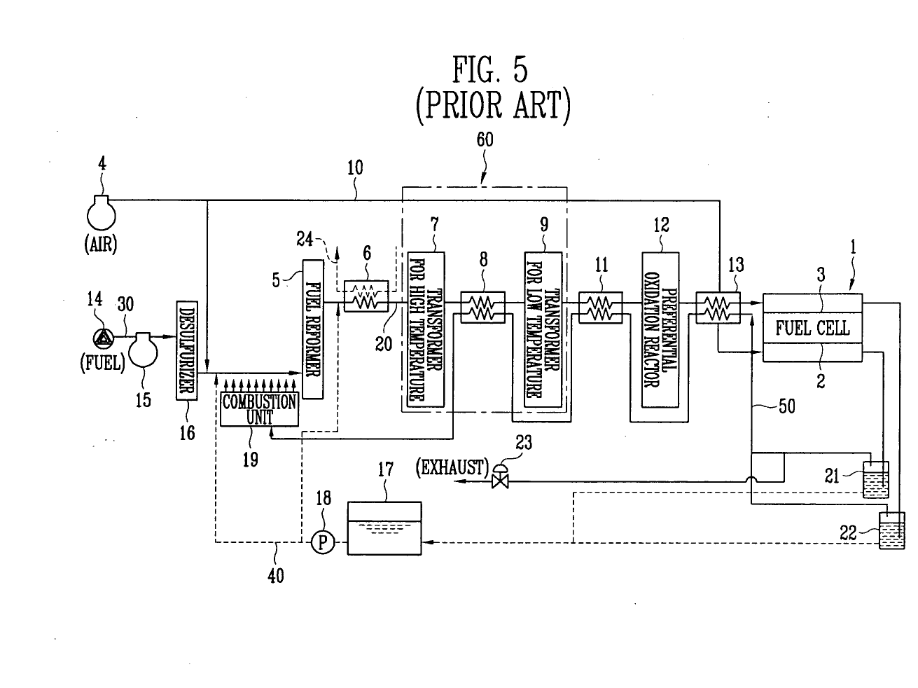

With respect to a reformer, Korean Patent Application Publication No. 2001-0104711 discloses a transforming apparatus with a shift reacting unit 10 for shifting a reformed gas containing abundant hydrogen generated from a reforming reactor 6 by a water gas shift reaction using a shift catalyst (FIG. 4). In such a transforming apparatus, a shift reacting unit 10 is provided to perform a shift reaction, while heat is exchanged with a raw gas by directly introducing the reformed gas from the reforming reactor 6 into a passage of the reformed gas. The transforming apparatus, the reforming reactor 6 and the shift reacting unit 10 are positioned in the same space defined by a thermal insulation material 19.

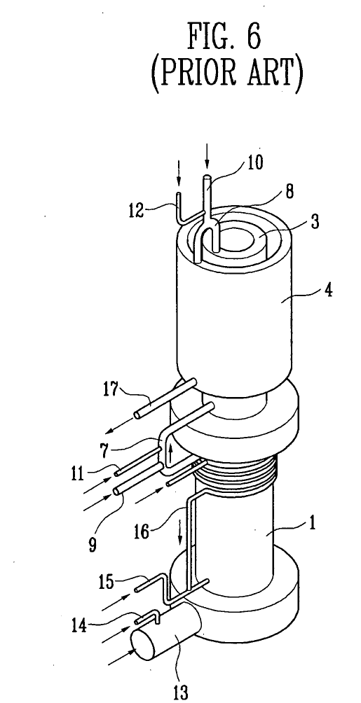

Also, Japanese Patent Application Publication No. 2001-115172 discloses a fuel cell with a carbon monoxide (CO) transforming apparatus. In the apparatus, a transformer for high temperature 7, a transformer for low temperature 9 and a heat exchanger 8 are positioned in one container 60 (FIG. 5). In such a fuel cell, the CO transforming apparatus is positioned in a direction in which a reformed gas is exhausted from a fuel reformer 5.

Japanese Patent Application Publication No. 1999-043303 discloses a reforming apparatus including a main combustion unit for supplying heat energy to a reforming reactor 1, and a shift reacting unit 3 for reducing the CO concentration in the reformed gas by a water gas shift reaction (refer to FIG. 6).

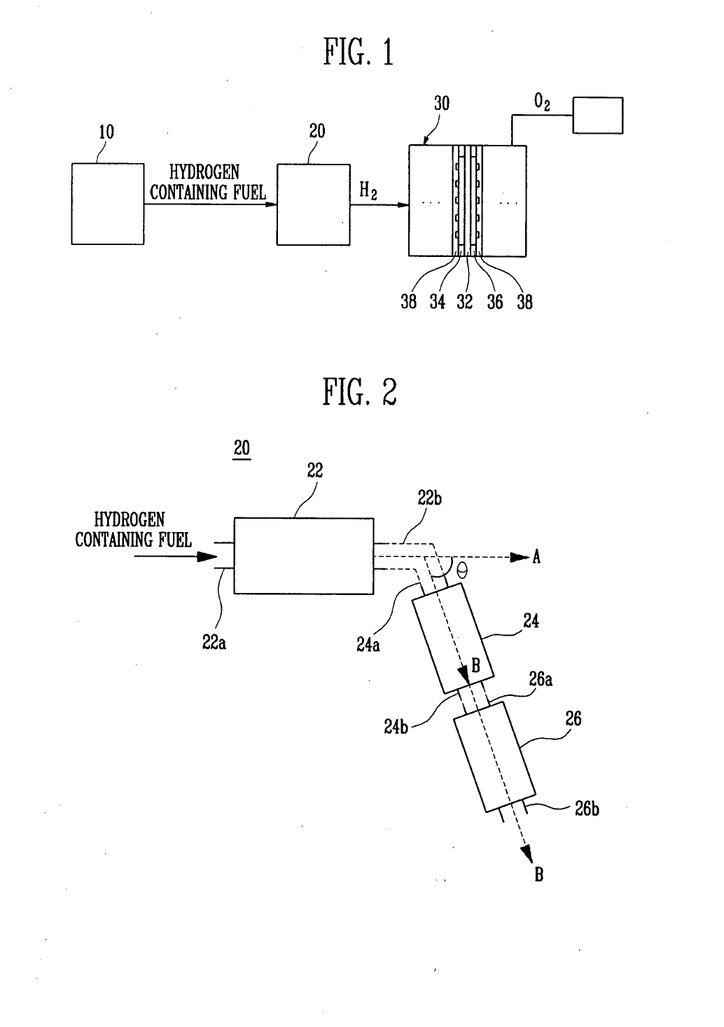

Referring to FIG. 1, a fuel cell includes a fuel feeder 10 storing a hydrogen-containing fuel to be reformed; a reformer 20 generating hydrogen gas by reforming the hydrogen-containing fuel supplied from the fuel feeder 10; and an electric generator 30 generating electricity through an electro-chemical reaction between hydrogen supplied from the reformer 20 and an oxidizer. Examples of a hydrogen-containing fuel used in a fuel cell system include, but are not limited to, an alcoholic fuel such as methanol, ethanol, etc.; a hydro-carbon fuel such as methane, propane, butane, etc.; and a natural gas fuel such as liquefied natural gas, etc.

In the illustrated embodiment, the oxidizer supplied to the electric generator 30 includes pure oxygen stored in a separate storing means or oxygen-containing air. The oxidizer is supplied from an air feeder to the electric generator 30. Meanwhile, the oxidizer may be supplied to a preferential oxidation unit of the reformer from the air feeder, as will be described below.

A portion of the hydrogen-containing fuel stored in the fuel feeder 10 may be supplied to a reforming reactor 22 of the reformer 20 as a reforming raw material. Another portion of hydrogen-containing fuel may be supplied to a heat source (not shown) for heating the reformer 20 as a combustion fuel.

Referring to FIG. 2, a reformer 20 includes a reforming reactor 22 and a carbon monoxide (CO) remover. The reforming reactor 22 is configured to generate a reformed gas having hydrogen gas as a main ingredient from a hydrogen-containing fuel supplied from the fuel feeder 10. The CO remover is configured to remove carbon monoxide contained in the reformed gas. The CO remover includes a water gas shifter 24 and a preferential oxidation unit 26. The reforming reactor and a CO remover are in fluid communication with each other.

In the context of this document, the term “straight moving direction” refers to a direction in parallel to a straight extension line extending between the inlet and outlet of the reforming reactor 22. In other words, a fuel inlet 22a through which a hydrogen-containing fuel flows and an outlet 22b through which the reformed gas flows out are positioned at both ends of the reforming reactor 22. The moving direction of the reformed gas is parallel to the straight extension line extending between the fuel inlet 22a and the outlet 22b, as indicated by an arrow A. The reformed gas generated from the reforming reactor 22 is exhausted through the outlet 22b of the reforming reactor 22 along the straight moving direction A.

The reforming reactor 22 is provided with a reforming catalyst (not shown). The reforming reactor 22 may reform a hydrogen-containing fuel, using steam reforming (SR), autothermal reforming (ATR) or partial oxidation (POX). While the partial oxidation and the autothermal reforming are excellent in response property, depending on an initial start and load variation, the steam reforming is excellent in the efficiency of producing hydrogen gas.

The steam reforming generates a reformed gas having hydrogen gas as a main ingredient through a chemical reaction between a hydrogen-containing fuel and steam on the catalyst. Steam reforming can generate hydrogen in a relatively high concentration because of a stable supply of the reformed gas.

In one embodiment where the reforming reactor 22 uses, for example, steam reforming, a portion of the hydrogen-containing fuel supplied from the fuel feeder 10, that is, the reforming fuel, is reformed into a reformed gas with rich hydrogen through the steam reforming reaction in the reforming catalyst, together with water supplied from the water supplier (not shown). The reforming catalyst may be a metal contained in a carrier. Examples of the metal include, but are not limited to, ruthenium, rhodium, and nickel. Examples of the carrier include, but are not limited to, zirconium dioxide, alumina, silica gel, activated alumina, titanium dioxide, zeolite, and activated carbon. The reformed gas includes a small amount of carbon dioxide, methane gas, and carbon monoxide. The carbon monoxide may deteriorate platinum used for an electrode of the electric generator 30, thereby adversely affecting the performance of the fuel cell system. Therefore, there is a need to remove the carbon monoxide.

The CO remover is connected to the reforming reactor 22 at a predetermined angle θ relative to the straight moving direction A of the reformed gas exhausted from the outlet 22b of the reforming reactor 22. The moving direction B of the reformed gas moving through the CO remover is parallel to a straight extension line extending between the fuel inlet and the outlet of the CO remover. Consequently, the predetermined angle θ is maintained between the moving direction B of the reformed gas moving along the CO remover and the straight moving direction A of the reformed gas exhausted from the reforming reactor 22. The tilt angle Θ may be from about 0° to about 180°.

In one embodiment, the CO remover includes a water gas shifter 24 and a preferential oxidation unit 26 which perform a water gas shift reaction and a preferential oxidation catalyst reaction, respectively. The water gas shifter 24 is provided with a shift catalyst (not shown). The preferential oxidation unit 26 is provided with an oxidization catalyst (not shown). The preferential oxidation unit 26 can be supplied with an oxidizer required for the preferential oxidation reaction from the air feeder.

The reformed gas exhausted from the outlet 22b of the reforming reactor 22 flows to the water gas shifter 24 through the first inlet 24a. A first reformed gas with carbon monoxide removed by the shift reaction is exhausted from the water gas shifter 24 through the first outlet 24b. The moving direction B of the first reformed gas exhausted through the first outlet 24b is parallel to the straight extension line extending between the fuel inlet 24a and the outlet 24b. The outlet 22b of the reforming reactor 22 and the first inlet 24a of the water gas shifter 24 can be connected to each other, for example, through a curved tube having a predetermined angle so as to be in fluid communication with each other. Accordingly, the reformed gas exhausted from the outlet 22b of the reforming reactor 22 can flow to the first inlet 24a of the water gas shifter 24 through the curved tube.

Likewise, the first reformed gas exhausted from the first outlet 24b of the water gas shifter 24 flows to the preferential oxidation unit 26 through the second inlet 26a. Hydrogen gas of high purity generated by removing carbon monoxide through preferential oxidation reaction in the preferential oxidation unit 26 is exhausted from the preferential oxidation unit 26 through the second outlet 26b. The moving direction B of the hydrogen gas exhausted through the second outlet 26b is parallel to the moving direction B of the first reformed gas. The moving direction B can be parallel to the straight extension line extending between the second inlet 26a and the second outlet 26b. For example, the first outlet 24b of the water gas shifter 24 and the second inlet 26a of the preferential oxidation unit 26 can be connected to each other so as to be in fluid communication with each other through a straight tube. Accordingly, the first reformed gas exhausted from the first outlet 24b of the water gas shifter 24 flows to the second inlet 26a of the preferential oxidation unit 26 through the straight tube.

The reformer 20 can be provided with a heat source generating heat energy by burning a portion of hydrogen-containing fuel supplied from the fuel feeder 10, that is, combusting fuel. The heat source is supplied with an oxidizer from the air feeder. The heat energy generated from the heat source is supplied to the reforming reactor 22 and the CO remover to heat them to their catalyst activation temperatures. For example, in the reforming reactor 22, the activation temperature of the reforming catalyst is about 700° C. or more. In the CO remover, the activation temperature of the shift catalyst is about 400 to 200° C. The activation temperature of the oxidation catalyst is lower than about 100° C.

As described above, while the reforming reactor 22 and the CO remover is maintained at the catalyst activation temperature by the heat energy supplied from the heat source, the hydrogen-containing fuel flows to the reforming reactor 22 as a reforming fuel from the fuel feeder 10 and water flows to the reforming reactor 22 from the water feeder (not shown). The reformed gas having, as main component, hydrogen gas formed by reforming the hydrogen-containing fuel on the reforming catalyst of the reforming reactor 22 through the steam reforming is exhausted through the outlet 22b along the moving direction as indicated by an arrow A and then flows to the water gas shifter 24 through the curved tube.

In the water gas shifter 24, carbon monoxide contained in the reformed gas is removed by reaction with water supplied from the outside so that a first reformed gas is generated. The first reformed gas is exhausted in the moving direction along the arrow direction B, and then flows to the preferential oxidation unit 26 through the straight tube.

Meanwhile, in the preferential oxidation unit 26, carbon monoxide remaining in the first reformed gas is removed by reaction with oxygen supplied from the outside so that the hydrogen of high purity generated from the reaction flows to the electric generator 30.

The electric generator 30 includes a plurality of unit cells. Each of the unit cells includes a membrane electrode assembly, and separating plates 38. The membrane electrode assembly is interposed between the separating plates 38. The membrane electrode assembly includes a polymer membrane 32 and electrodes 34 and 36. The polymer membrane 32 is interposed between the electrodes 34 and 36. The separating plates 38 are configured to supply hydrogen and oxygen to the membrane electrode assembly. The separating plate 38 is not limited thereto, but it may be a bipolar plate that is interposed between the membrane electrode assemblies. The bipolar plate has a hydrogen channel for supplying hydrogen on one side thereof and an oxygen channel for supplying oxygen on the other side thereof.

In the illustrated embodiment, hydrogen gas of high purity supplied to the electric generator 30 from the preferential oxidation unit 26 is supplied to the anode electrode 34 of the membrane electrode assembly through the hydrogen channel of the separating plate 38. Oxygen gas supplied to the electric generator 30 from the air feeder is supplied to the cathode electrode 36 of the membrane electrode assembly through the oxygen channel of the separating plate. The electricity is generated by the hydrogen oxidizing reaction in the anode electrode 34 and the oxygen reducing reaction in the cathode electrode 36 and water is generated as a by-product

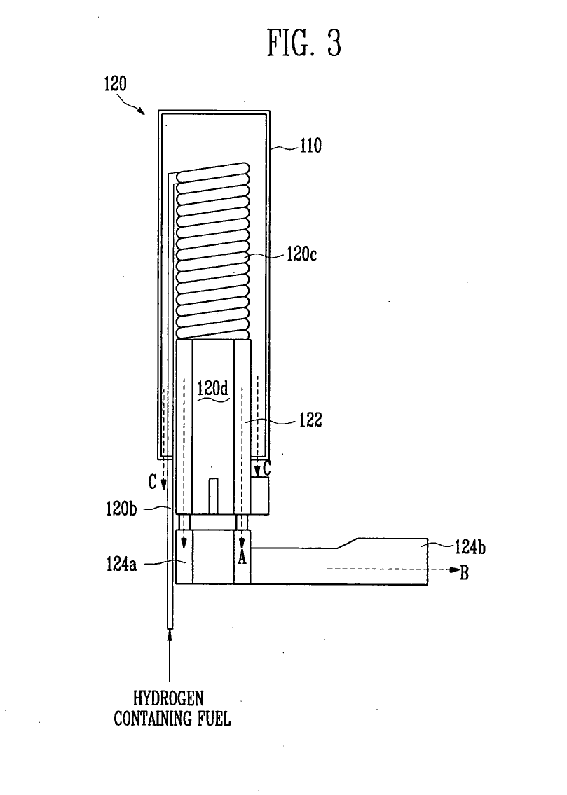

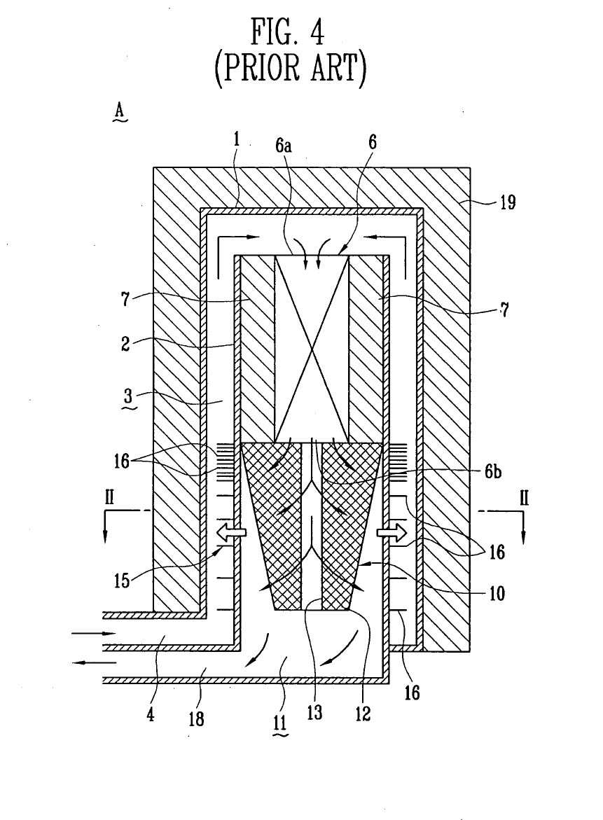

Hereinafter, the reforming reaction in the reformer according to one embodiment using the fuel containing hydrogen will be described. Referring to FIG. 3, the reformer 120 according to one embodiment includes a raw material inflow tube 120b through which butane and water flow, an evaporator 120c for evaporating the butane and the water flowing in through the raw material inflow tube 120b, a reforming reactor 122 forming the reformed gas through the steam reforming reaction of steam and butane in gas phase supplied from the evaporator 120c, and water gas shifters 124a and 124b for removing carbon monoxide contained in the reformed gas generated from the reforming reactor 122. The reference numeral 120d is a combustion unit for supplying heat energy to the evaporator. A cover 110 is provided outside of the evaporator in order to recover heat contained in an exhausting gas generated from the combustion unit 120d.

The cover 110 is provided over the evaporator and the reforming reactor 122. The exhausting gas is exhausted in an arrow direction C through a gap between the reforming reactor 122 and the cover 110. At this time, the reformed gas generated by the reforming action in the reforming reactor 122 is moved in the arrow direction A. The moving direction A of the reformed gas is substantially maintained parallel to the moving direction of the exhausting gas.

In the illustrated embodiment, a shift catalyst for high temperature having a catalyst activation temperature of relatively high temperature, for example, about 400° C. is built in the first water gas shifter 124a. A shift catalyst for low temperature having a catalyst activation temperature of relatively low temperature, for example, about 200° C. is built in the water gas shifter 124b. The shift catalyst for high temperature is formed of Fe—Cr based catalysts and the shift catalyst for low temperature is formed of Cu—Zn based catalysts.

According to one embodiment, the first water gas shifter 124a is positioned along a path of the moving direction C of the exhausting gas, while the second water gas shifter 124b is installed in a direction substantially normal to the moving direction C of the exhausting gas. It is to prevent an effect on the second water gas shifter 124b by heat energy contained in the exhausting gas.

Therefore, when the evaporator 120c is sufficiently heated by heat energy generated from the combusting action in the combustion unit 120d, the butane and the water in liquid phase supplied through the raw material inflow tube 120b are changed into gas phase. The butane and the steam in gas phase are shifted into a reformed gas containing mainly hydrogen gas through the steam reforming reaction in the reforming reactor 122. The reformed gas flows to the first water gas shifter 124a in the arrow direction A and then moves to the second water gas shifter 124b in the arrow direction B.

While the reformed gas passes through the first water gas shifter 124a and the second water gas shifter 124b, carbon monoxide contained in the reformed gas is removed so that a first reformed gas with reduced carbon monoxide content is generated. The first reformed gas flows to the preferential oxidation unit 26 (refer to FIG. 2) to remove the remaining carbon monoxide so that the hydrogen of high purity is generated. At this time, the temperature of the reformed gas generated from the reforming reactor 122 lowers to about 400° C. by the heat exchanger (not shown) and flows to the first water gas shifter 124a. The temperature of the second reformed gas generated from the first water gas shifter 124a lowers to about 200° C. by the heat exchanger (not shown) and flows to the second water gas shifter 124b.

According to the embodiments described above, the CO remover is disposed in a predetermined tilt angle to the straight moving direction of the reformed gas exhausted from the reforming reactor so that the CO remover is not subject to the heat energy effect by a heat transfer effect due to air convection from the reforming reactor, making it possible to keep the CO removing unit in an optimal state to improve reforming efficiency.

Although a few embodiments have been shown and described, it would be appreciated by those skilled in the art that changes might be made in this embodiment without departing from the principles and spirit of the invention, the scope of which is defined in the claims and their equivalents.

What is claimed is:

1. A reformer for use in a fuel cell, comprising:
a reforming reactor comprising a first inlet and a first outlet, the first outlet being configured to exhaust a fluid generally in a first direction;
a carbon monoxide remover comprising a second inlet and a second outlet, the carbon monoxide remover being configured to flow at least part of the fluid therethrough at least partially in a second direction different from the first direction; and
a conduit configured to guide the at least part of the fluid from the first outlet to the second inlet.

2. The reformer of claim 1, wherein the reforming reactor is configured to flow the fluid therethrough generally in the first direction.

3. The reformer of claim 1, wherein the second inlet of the carbon monoxide remover is configured to flow the at least part of the fluid therethrough generally in the second direction.

4. The reformer of claim 1, wherein the conduit comprises a curved tube permitting fluid communication between the first outlet and the second inlet.

5. The reformer of claim 1, wherein the reforming reactor is configured to operate at a first temperature, and wherein the carbon monoxide remover is configured to operate at a second temperature lower than the first temperature.

6. The reformer of claim 5, wherein the first temperature is equal to or greater than about 700° C., and wherein the second temperature is from about 200° C. to about 400° C.

7. The reformer of claim 1, wherein the carbon monoxide remover comprises a water gas shifter and a preferential oxidation unit in fluid communication with each other, at least one of the water gas shifter and the preferential oxidation unit being configured to flow the fluid generally in the second direction.

8. The reformer of claim 7, wherein the water gas shifter includes the second inlet, and wherein the preferential oxidation unit includes the second outlet.

9. The reformer of claim 7, wherein the water gas shifter comprises a first shifter and a second shifter in fluid communication with each other, the first shifter being configured to operate at a third temperature, the second shifter being configured to operate at a fourth temperature lower than the third temperature, wherein at least one of the first and second shifter is configured to flow the fluid generally in the second direction.

10. The reformer of claim 9, wherein the second shifter comprises an inlet and an outlet aligned along an axis extending in the second direction.

11. The reformer of claim 1, wherein the reforming reactor further comprises a heat source configured to supply heat to the reforming reactor.

12. The reformer of claim 11, wherein the heat source is configured to exhaust at least part of the heat in a third direction different from the second direction.

13. The reformer of claim 12, wherein the third direction forms an angle with the second direction, and wherein the angle is between about 0° and about 180°.

14. The reformer of claim 12, wherein the third direction is substantially the same as the first direction.

15. The reformer of claim 1, wherein the first direction forms an angle with the second direction, and wherein the angle is between about 0° and about 180°.

16. The reformer of claim 1, wherein the first inlet and first outlet of the reforming reactor are positioned generally along a first axis extending in the first direction.

17. The reformer of claim 1, wherein the second inlet and second outlet of the carbon monoxide remover are positioned generally along a second axis extending in the second direction.
